(19) United States
(12) Patent Application Publication
(10) Pub. No.: US 2025/0259475 A1
(43) Pub. Date: Aug. 14, 2025

(54) SYSTEM, METHOD, SERVER AND ELECTRONIC DEVICE FOR COMPUTER IMPLEMENTED ASSISTING THE IDENTIFICATION OF PREFERENCES OF A USER WITH RESPECT TO DIFFERENT CANDIDATES PRESENTED TO THE USER

(71) Applicant: ARS SOFTWARE SOLUTIONS AG, Baar (CH)

(72) Inventor: Sebastian WOWRA, Unterägeri (CH)

(21) Appl. No.: 18/854,785

(22) PCT Filed: Jun. 16, 2022
(86) PCT No.: PCT/EP2022/066514

§ 371 Date: Oct. 7, 2024

(30) Foreign Application Priority Data
Apr. 6, 2022 (CH) CH000380/2022

(51) Int. Cl. G06V 40/16; G06V 10/74; G06V 10/75; G06V 10/77; G06V 10/94; G06V 20/40

(52) U.S. Cl. CPC G06V 40/171; G06V 10/75; G06V 10/761; G06V 10/7715; G06V 10/95; G06V 20/46

(57) ABSTRACT

A system for computer implemented assisting the identification of preferences of a user with respect to different candidates presented to the user comprises a camera (11) arranged and configured to capture images (IMGx) of the user's face. A face recognition engine (21) is configured to extract features from one or more captured images (IMGx) of the user's face in response to a candidate (pCAx) being presented to the user (U). A matching engine (22) is configured to assign a satisfaction value (SVx) to the extracted features, the satisfaction value (SVx) representing the user's satisfaction with the presented candidate (pCAx). The matching engine (22) is further configured to select, for presentation, one or more further candidates (fCAx) dependent on satisfaction values (SVx) assigned with reference to candidates (pCAx) presented to the user (U) so far.

### CROSS REFERENCES TO RELATED APPLICATIONS

This application claims the priority of Swiss patent application CH000380/2022, filed Apr. 6, 2022, the disclosure of which is incorporated herein by reference in its entirety.

### TECHNICAL FIELD

The invention refers to a system, method, server and electronic device for computer implemented assisting the identification of preferences of a user with respect to different candidates presented to the user.

### BACKGROUND ART

In computer implemented assisting a user in taking decisions with respect to candidates presented, a problem still relies in efficiency.

### DISCLOSURE OF THE INVENTION

This problem is solved by a system for computer implemented assisting the identification of preferences of a user with respect to different candidates presented to the user.

A user is a human being who shall be supported in taking a decision by means of the present system and method. A candidate represents an option. A set of candidates represents the candidates the user is expected to finally select one or more candidates from. Hence, candidates, in present scenario compete with each other, and hence differ from each other. The term candidate is interpreted broadly. A candidate addresses at least one of the senses of the user. Accordingly, a candidate is a concrete sensation for the user, the sensation being one of a visual, an auditory, an olfactory, a tactile and a gustatory sensation. Hence, the presentation of a candidate to the user is intended to stimulate preferably one of his/her visual, auditory, olfactory, tactile or gustatory sense. Candidates may be items, human beings, animals, scenes, events, etc. The presentation of candidates to the user depends on which sense of the user shall be affected. In case of the visual sense to be affected, for example, the candidate is visible to the user. The presentation medium for such candidate may e.g. be a picture or a video. In other embodiments, the presentation medium may be a stage for live performances, for example. In case the auditory sense of the user is to be addressed, for example, a candidate may be a sound, a song, or noise. Candidates may also be odours, tasty items, surfaces, for e.g. addressing the olfactory, gustatory or tactile sense of the user. Preferably, a control unit, including the later introduced matching engine is capable of presenting or initiating presentation of the candidates to user in an automated manner.

A user being exposed to or being presented different candidates to select from typically shows different reactions in terms of gestures, and in particular different facial expressions subject to his/her preferences as to the different candidates. Accordingly, the presentation of a candidate may trigger a facial expression in the user, such as sympathy or antipathy facial expressions, in other words satisfaction or dissatisfaction, to name only two.

The facial expression of the user is monitored by a camera. In particular the facial expression is monitored by the camera during or in response to a new candidate being presented to the user in order to monitor the facial reaction of the user with respect to the new candidate. Accordingly, it is preferred that the facial expression of the user is monitored and evaluated. Preferably, also the dynamics in the facial expression is monitored and evaluated, e.g. between a scenario in which no candidate stimulus is presented and a scenario with a candidate stimulus.

Given that the evaluation of the facial expression is to be performed computer implemented, images of the user's face are captured or taken by a camera directed at the user's face while candidates are presented to the user. Such images may be taken under control of a program sequence. Preferably, the timing of image capture may in addition or alternatively be determined relative to the timing of presenting a candidate, e.g. with a certain delay after having presented a new candidate to the user. Or, images may be taken at fixed, pre-determined intervals. Or images may be captured in more or less permanent manner in form of a video, and still images may be extracted from the video there after.

The camera preferably is a conventional 2D camera with a sufficient resolution to identify features in images taken from the face of the user. The camera can be a camera integrated into an electronic device, such as the camera of a smartphone, or may be a stand-alone camera connected to an electronic device via cable or wireless. Preferably, the electronic device is a personal electronic device of the user in order to enable the user to conduct the selection process at any time and at any location as desired. The camera preferably supplies digital images that are stored or at least cached.

The multiple candidates available build a set of candidates. In case the presentation medium for the candidates is electronic files, such as image or video files of the candidates, it is preferred that a database is provided storing the set of candidates.

It is preferred that only one candidate is presented to the user at a time. Given that the face of the user captured by the camera is of interest as a reaction to the candidate being presented to the user, it is preferred that a data structure is maintained that maps the one or more images captured or data derived from such images e.g. by feature extraction to the presented candidate. Preferably, such data structure comprises at least the image captured and/or derived data and/or a pointer to the storage location for the image, and the image or video of the candidate presented while the image/s are taken, or, more preferably, a unique identifier for the candidate presented.

In order to assess the facial expression of the user in response to a candidate presented to the user, a face recognition engine is provided that is configured to extract features from one or more images captured in such situation. The face recognition engine is described in more detail later on.

A matching engine evaluates the features extracted by the face recognition engine and is supposed to output a measure for the facial expression. The matching engine preferably determines the measure by comparing the feature vectors extracted for many different images, preferably taken when the user is stimulated by one candidate, but preferably also taken when the user is stimulated by one or more other candidates. Preferably, the matching engine makes use of a machine learning model for determining the measure. Such measure may e.g. be referred to as degree of satisfaction. Preferably, a satisfaction value is assigned to the extracted features by the matching engine, which satisfaction value preferably is a value of an index, such as a satisfaction index providing graded values between absolute satisfaction and absolute dissatisfaction. Preferably, the satisfaction value is stored in the data structure and hence is assigned at least to the candidate presented while the image is taken, but preferably also to the features extracted from the corresponding image/s.

Finally, the matching engine is also responsible for selecting, or for requesting to select or for initiating to select one or more further candidates to be presented to the user. The selection is based on the assigned satisfaction value and on one or more satisfaction value/s determined in relation with one or more candidates previously presented to the user, preferably in the same user session. In relation means that those satisfaction value/s are determined from images captured while having presented one or more different candidates in the past.

The selection process for further candidate/s to be presented, preferably out of the set of candidates, accelerates the overall period required for the user session. A user session preferably starts by the user opening a corresponding app, or, with the user being ready to be exposed to candidates. A user session preferably terminates with the user actively terminating actively the selection process or the app, or with the system terminating the selection process by presenting the most preferred candidate/s to the user. Accordingly, the present invention avoids the need for the user to browse all candidates available and getting bored while doing so. It enables the user to browse only a subset of candidates, without degrading the result. In addition, the processing effort is limited over a scenario in which all candidates need to be browsed by the user resulting in a corresponding high number of images and corresponding data structures for feature values etc. Hence, storage requirements are minimized, too, given that fewer data structures need to be stored.

For example, the system is configured to, after a certain time spent by the user on browsing candidates, or after a given number of candidates being browsed by the user, to automatically identify the highest satisfaction values assigned to any of the candidates presented so far. Accordingly, the system knows the candidates that are preferred over others by the user. This knowledge can be exploited as follows: In one example, the matching engine is configured to select the one or more further candidates with similar characteristics as the ones high rated so far, in order to even find a better match for the user. When the user will be presented these one or more further candidates, it is expected that his/her facial expression is in a satisfying range, too, and may even show a higher satisfaction level.

In a different strategy, it may be desired to the present one or more further candidates with opposite characteristics. This strategy may be used to double check the satisfaction values assigned so far, given that a satisfaction value in the dissatisfaction range would be expected in response to presenting one or more candidates with opposite characteristics.

Both strategies may be implemented sequentially. First, the high satisfaction values assigned so far are challenged by presenting one or more further candidates with opposite characteristics than the ones appreciated so far. When confirmed, one or more further candidates with similar characteristics may be selected for presentation in order to even optimize the result achieved so far.

In this context, the characteristics of candidates are preferably assessed, in order to identify similar or dissimilar candidates out of the set. Although not limiting the scope of the invention, in order to facilitate explaining the selection process it is only referred to candidates affecting the visual sense of the user. Preferably, such candidates are presented to the user on a screen or a display in form of pictures or videos. Candidates may be items, human beings, animals or scenes. In one example, the candidates are human beings and the application of the system may be dating. Hence, pictures show candidates as potential dates, e.g. their faces, and those candidates are presented to the user on the screen. The user's reaction on the presentation of a candidate is captured by the camera. The corresponding image/s having captured the user's face as reaction to the presented candidate is/are evaluated with respect to the facial expression, for deriving a satisfaction value.

In one embodiment, the matching engine is configured to select the one or more further candidates out of the set by way of selecting at least one candidate out of the candidates presented subject to the corresponding satisfaction values, e.g. with the highest satisfaction value/s, or with the lowest satisfaction value/s as indicated above. Then, the respective candidate is computer implemented assessed as to his/her characteristics. In a subsequent step, the one or more further candidates are selected from the set subject to a similarity measure with respect to this selected candidate. Accordingly, one or more further similar candidates will be presented, be it similar in sympathy, or similar in antipathy.

For extracting the characteristics of a candidate from his/her picture, assuming that the candidate is a person, a computerized pattern recognition engine may be used for extracting features from the pictures or videos of the candidates. The result is a candidate feature vector, wherein the feature vector for the candidate yet presented and having received e.g. the highest or the lowest satisfaction value, is referred to as reference candidate vector.

There are different ways of implementation: In one embodiment, the entire set of candidates is assessed up-front of running a user session. Here, the set of candidates, e.g. stored in a database, not only contains a picture of the candidate as database entry, but also a pattern or feature vector, denoted as candidate feature vector representing data extracted from the picture of the candidate and identifying the at least optical/visual characteristics of the candidate in a way that allows comparison with the feature vectors for other candidates. Accordingly, the step is performed prior to a user session. The step may be performed by the service provider or the customer, see below. At run time, i.e. during a user session, no candidate feature extraction is required, only a matching or comparison step between the reference candidate feature vector and feature vectors of other candidates. In case the database containing the set of candidates and the corresponding candidate feature vectors is located remote from the server site offering the services to the user, only candidate identifiers may need to be exchanged between the server and the database. E.g., the id for the candidate with the highest satisfaction value is submitted to the database, the corresponding reference candidate vector is read from the database, and a pattern recognition engine e.g. at the remote location runs the matching between the reference candidate feature vector and the candidate feature vectors for other candidates of the set. Preferably, such matching steps are only run for the candidates of the set not presented yet to the user, which represent a subset of the set. In case of very large sets of candidates, the subset may not only be defined by the candidates not presented yet, but by an arbitrary subset of the subset of candidates not presented yet. Preferably, tags are provided in the database for candidates being already presented per user or not being presented per user.

In a different embodiment, the candidate feature vectors are generated prior to runtime, but outside the server of the service provider, e.g. at a remote location that hosts the database. In the above embodiment, the matching engine may also be a distributed matching engine that e.g. performs the image matching on the server while the candidate matching is performed in the location remote from the server.

In a different embodiment, the candidates feature extraction as well as the matching are performed during run time. Accordingly, no upfront candidate vectors exist, but are generated at the point in time when the selection of the one or more further candidates is started. In this embodiment, the reference candidate vector may be generated and supplied to the location of the database to be matched with the candidate feature vectors there. In case the server hosts the database, too, the matching engine may completely run on the server and perform the image matching as well as the candidate matching.

Generally, the matching between the reference candidate feature vector and other candidate feature vectors is performed by way of comparison of these vectors resulting in one or more relative quantities, which indicate similarity. Accordingly, the one or more further candidates to be presented to the user are selected dependent on the relative quantities between the candidate feature vector and the reference candidate feature vector. E.g. the selection criterion may be that the amount of e.g. averaged relative quantity, relative quantities are also referred to as distances, is below or above a threshold for a candidate to be selected as further candidate.

In particular when the candidates of the set are human beings, the face recognition engine used for extracting features from the images captured by the camera can be used as pattern recognition engine for generating candidate feature vectors for (the faces) of the candidates. In other embodiments, the pattern recognition engine may be a software engine different to the face recognition engine.

In an application different to the above one, e.g. where the candidates are different dishes presented on pictures, for a user to select the preferred food either in a restaurant, at home, or elsewhere, the process is the same: After a couple of candidates have been presented to the user, the interim results in terms of satisfaction values are evaluated and used for the selection of one or more candidates for future presentation to the user. The one or more further candidates may show either similarities or dissimilarities on purpose to the candidates presented to the user and rated with the highest satisfaction value so far.

In one embodiment, the matching engine is triggered for the sub-process of selecting the one or more further candidates after a minimum number of candidates has been presented to the user. In case the candidates are presented to the user on a screen, the number can automatically be measured, and the sub-process of selecting the one or more further candidates is automatically triggered when the minimum number is reached. In a different embodiment, a different trigger may be used, such as the overall time spent so far in the user session exceeds a given limit. It is preferred, that only after some time and the first evaluation results the sub-process of selecting further candidates is started which sub-process preferably makes use of the evaluations of a number of different candidates so far. In a different embodiment, the minimum number of candidates to be presented before starting the sub-process is two, given that the sub-process can start with looking for similarities in the extracted features of the higher ranked candidate out of the two, and evolve from there.

The candidates presented at the beginning of the user session may also be pre-ordered and/or preselected in order to test the facial expressions of the user to very different characters in case of the candidates being human beings. For example, either a human being, or a software engine browses the database of candidates and selects very different profiles, e.g. as to gender, age, ethnic group, in order to allow to determine the basic preferences of the user with a first small subset of candidates. Only then, the sub-process as laid out above may be triggered, and the remaining candidates of the set, i.e. the ones not presented yet, may be assessed for similarity to the candidate/s with the highest satisfaction value so far. In a different embodiment, and subject to the overall size of the set, only a subset of the remaining candidates may be assessed for e.g. similarity or dissimilarity.

As already indicated above, it is preferred that the user is supported in the selection process by an electronic device such as a smartphone, a tablet computer, a laptop, another kind of handheld computer, a stationary computer such as a PC, or another kind of stationary computer. The electronic device represents an entity of the system and preferably comprises an integrated camera, and an integrated display or screen, as well as a processing unit. Alternatively, camera and screen may be connectable to the electronic device. The camera is configured and also arranged to record the facial expression of the user, while the display is configured to present candidates to the user. Specifically, a presentation engine may be provided in the electronic device for presenting candidates to the user on the screen.

Preferably, the system comprises a server. The server is in the domain of a service provider offering his/her services to users. The server preferably comprises the matching engine and can communicate with the electronic device via a suitable interface. In particular, the electronic device may comprise an application (app) configured to implement the desired functionality on the electronic device of the user. Such app may be downloaded by the user to the electronic device prior to usage of the envisaged service. The app is configured to provide a graphical user interface for the user to control the app, settings of the app, the process run by the app, the presentation engine configured to present candidates received from the server via the display to the user, e.g. at a given rate and/or on demand, and/or to control the capturing of images from the user's face e.g. at a given rate while the user watches the candidates which images in one embodiment are forwarded to the server 2 for further assessment. In such scenario, the face recognition engine and the matching engine are both located on the server, and the images captured from the users face are transferred from the electronic device to the server while the pictures of the candidates are transferred from the server to the electronic device to be presented there. In a different embodiment, the face recognition engine may be resident on the electronic device and e.g. may be part of the app to be downloaded on the user's electronic device for making use of the provider's services. In such scenario, the features may be extracted on the electronic device, and only the feature vectors are transmitted to the server, while the captured images may remain on the electronic device of the user, which may enhance privacy for the user's personal data. In such scenario, the server, and in particular the matching engine may perform the mapping between feature vector/s and/or the satisfaction value and the candidate and the filling of the corresponding the data structure.

In one embodiment, the database with the set of candidates is stored on the server. In a different embodiment, the database may be stored on a different server in the domain of a customer of the service provider. E.g., such customer may define the candidates upfront he/she wants to offer to the users. In addition, the candidates may need to be updated on a regular basis which is implemented on the other server. In such scenario, server comprises an interface for communicating with the other server.

In the first scenario with the database resident on the server of the service provider, the matching engine may directly perform the selection of the one or more further candidates out of the database. However, in the other scenario with the database resident on the other server, e.g. belonging to the customer of the service provider, the matching engine of the server preferably directs a request for selecting further one or more candidates for presentation from the database on the other server. Here, the other server may comprise a face recognition engine extracting features from the pictures of the candidate's faces, while the server submits the identifier of the highest ranked candidate or the corresponding extracted features for selecting one or more further candidates with similar extracted features. Accordingly, this task may be performed on the other server in case the customer is not willing to share the full set of candidates with the service provider, or may be performed on the server of the service provider in case the customer is willing to share the candidates with the service provider, either upfront or on demand.

Between the server and the electronic device, it is preferred that the matching engine on the server controls the presentation engine on the electronic device by submitting the one or more candidates or the one or more further candidates for presentation in a sense that the pictures of these candidates are selectively transferred to the electronic device, preferably allowing the presentation engine only to display the candidates without storing, also owed to privacy considerations.

The face recognition engine is configured to computer implemented identify features of images recorded by the camera. The face recognition engine may be considered as special type of a pattern recognition engine that is programmed and/or trained to identify facial characteristics. Facial characteristics may include position and/or shape and/or size of landmarks in the image of the face captured by the camera. Landmarks may e.g. include eyes, eyebrows, eyelid, eye opening, distance between the eyes, nose, pupil, liver spots. But also the shape of the head as such can be taken as landmark. Facial characteristics may also include facial expression, also referred to as facial semantic features, indicating states of emotion, such as happy, non-happy, interested, non-interested, disgust, wondering, skepticism, surprise, etc.

Accordingly, the face recognition analyses the face of the user as image content. The computer implemented analysis, which generally also is named image processing, in particular makes use of feature extraction. A feature generally is considered a shape, contour, area recognizable in the digitized image by way of e.g. comparing colour steps etc. Given that the image is the image of a human face, features may include the above listed landmarks e.g. eyebrows, eyes, nose, mouth, lid, cheek, etc. In feature extraction, the volume of data inherent in a pixel based digital image is transformed into a set of features also referred to as feature vector, and thereby is significantly reduced, and hence can also be regarded as form of compression.

In one embodiment, the features to be extracted are defined upfront, e.g. by means of feature selection. For example, it is defined that the above set of exemplary features mouth, nose, eyes, etc., are selected as relevant features for subsequent feature extraction from the images taken. Corresponding information may facilitate the feature extraction from captured images, e.g. such that eyes are found to the left and right of the nose etc. Preferably, the face recognition engine comprises a feature extractor specifically trained to extract facial characteristics.

Features, in particular selected features may be classified into quantifiable features and non-quantifiable features. In the class of quantifiable features, a metric can be applied, such as a distance: mouth open, eye open, pupil size, nose size, etc. In the class of non-quantifiable features, no such single metric can be assigned. Instead semantic states such as facial expression such as happy, interested, bored, engaged, are relevant features.

Accordingly, the feature extractor preferably comprises a first feature extractor module trained to extract quantifiable features from the image/s, and a second feature extractor module trained to extract other features from the image/s subject to the extracted quantifiable features. Preferably, both feature extractors make use of a trained model. Preferably, the first and the second feature extractor are pipelined, in particular with a result of the first feature extractor being input to the second feature extractor. Specifically, the second feature extractor is configured to select between different trained models subject to the extracted quantifiable features supplied from the first feature extractor. For example, by means of the first feature extractor, i.e. based on the extracted quantifiable extracted features, gender, age and ethnic group of the user can be determined. Accordingly, a model is selected for the second feature extractor that puts the features extracted by the second feature extractor in relation to the model representing the determined age, gender and ethnic group. This is owed to facial expressions being largely different subject to age, gender and ethnic group. Accordingly, the provision of two pipelined feature extractors as outlined above facilitates the correct analysis of facial expressions of the user irrespective of age, gender and ethnic group.

A final feature vector is determined and stored, either based on feature vectors from the individual feature extractors, or assembled during processing. Such feature vector is considered as an array of data and/or numbers representing the facial expression and landmarks of the user. Such feature vector is of dimension as be comparable to other feature vectors generated during the selection process. A comparison between two feature vectors, preferably by means of the matching engine, results in one or more relative quantities that indicate differences in the facial characteristics between the faces on two images, the larger the relative quantities are, the more different, the lower the relative quantities are, the more similar the facial characteristics are.

While feature vectors of images captured as response to the exposure of the user to different candidates may indicate different facial expressions “under stimulus”, i.e. during exposure to a candidate, it is desired to also have a reference feature vector available for the specific user that represents an idle facial expression, i.e. an image captured while the user is not exposed to any candidate. Accordingly, the system is configured to capture at least one image from the user absent the exposure of the user to any candidate. Such one or more images are also referred to as reference images, and the features extracted from such reference image are denoted as reference features, resulting in a reference feature vector. The reference feature vector preferably is of the same dimension such as the other feature vectors extracted, such that it can be compared to any of the other feature vectors calculated. In particular, the system, and preferably its matching engine is configured to compare one or more of the feature vectors resulting from user faces under stimulus with the reference feature vector absent any stimulus for the user. Such process is also referred to as calibration, and the result of such comparison is one or more relative quantities. Accordingly, any facial expression can be better assessed when calibrated, i.e. put into relation to the reference facial expression absent any candidate stimulus. In particular, these relative quantities are transformed into the satisfaction value, but also relative quantities between two feature vectors under stimulus can contribute to the satisfaction value.

Preferably, the matching engine is configured to terminate a user session automatically. Given that it is not desired to present all candidates of the set to the user but to more efficiently present only a subset, it is preferred that the matching engine may stop further presentation of candidates in case a defined satisfaction value or level is met by at least one candidate. Other termination events are possible. Preferably, the matching engine outputs the one or more preferred candidates, i.e. the one or more candidates with the highest satisfaction level to the user, e.g. on the display of the electronic device.

According to another aspect of the present invention, in a computer implemented method for assisting a user in identifying preferences with respect to different candidates presented to the user, a candidate is presented to the user. While the candidate is presented to the user, one or more images of the user's face are captured, preferably by a camera directed at the user's face. Features are extracted from the one or more captured images of the user's face, and a satisfaction value is assigned to the extracted features, the satisfaction value representing a user's satisfaction with the presented candidate. Finally, one or more further candidates are selected for presentation to the user, dependent on satisfaction values assigned with reference to candidates previously presented to the user.

Preferably, quantifiable features are extracted from the image/s resulting in a first feature vector. Other features are extracted from the image/s next subject to the extracted quantifiable features, resulting in a second feature vector. First and second feature vectors are combined into a feature vector assigned to the image/s and the feature vector is stored in a data structure preferably in combination with one or more of the assigned satisfaction value, the picture, video or identifier of the associate candidate, and the one or more images underlying the feature vector.

Specifically, it is preferred in the above embodiment to select a facial model based on one or more of the extracted quantifiable features, and to apply the selected facial model in the next step of extracting the other features. Preferably, the facial model is a facial model representing an ethnic group the user is identified to belong to based on the one or more extracted quantifiable features.

Again, for calibration purposes, it is preferred that one or more reference images of the user are captured while no candidate is presented to the user. Reference features are extracted from the one or more captured reference images of the user's face, and a reference feature vector is generated from the extracted reference features comparable to feature vectors generated for other captured images. Preferably, the or each feature vector is calibrated with respect to the reference feature vector to obtain one or more relative quantities, and the satisfaction value dependent on the one or more relative quantities. Again, the or each feature vector may also be compared with one or more other feature vectors to obtain one or more relative quantities, and the satisfaction value may be assigned dependent on the one or more of these relative quantities.

It is preferred that these more reference images are captured prior to the user being presented any candidate. In addition, such reference images may also be taken in breaks between two intervals in which intervals candidates are presented, in particular in case the intervals are fixed intervals provided by the system.

As to the selection of the one or more further candidates, it is preferred that at least one candidate is selected out of the candidates presented so far subject to the corresponding satisfaction values. The one or more further candidates are then selected based on a similarity measure between the least one selected candidate and other candidates not presented yet. The at least one selected candidate may e.g. be the candidate with the highest satisfaction value.

In particular in case the candidates of the set are represented by one of human beings, animals, items, text and scenes, or a combination thereof, the candidates are presented to the user in form of pictures or videos on a display. In such scenario, it is preferred that features are extracted from the picture or video of the at least one selected candidate thereby generating a corresponding reference candidate feature vector. Features are also extracted from the pictures or videos of other candidates not presented yet, either all or a subset of, thereby generating corresponding candidate feature vectors. The reference candidate feature vector is then compared with the candidate feature vectors to obtain one or more relative quantities, and the one or more further candidates are preferably selected dependent on the one or more relative quantities. For example, the one or more further candidates are then selected according to one or more of the highest and lowest one or more relative quantities. In other words, the one or more further candidates shall be candidates similar to the preferred one of the candidates selected so far, or opposite to the preferred one.

Finally, after presentation of the one or more further candidates, the candidate/s with the highest satisfaction value, and/or the candidate/s exceeding a minimum satisfaction value—i.e. a satisfaction value threshold—may be selected for a list of preferred candidate/s, which list preferably is presented to the user, e.g. on the screen.

In a different embodiment, after the generation of the list, the candidates of the list are not yet presented to the user. Instead, it is verified if a supplier of the candidates, i.e. a customer of the service provider, is flagged in a database of suppliers/customers with a flag, also referred to as complex attribute, indicating special treatment and/or special preferences as to the selection process. The “complex attribute” may indicate one or more of the following: In a first variant, the customer may require an individual, and preferably a higher satisfaction value threshold for a candidate to be added to the list of suggested candidates than a default satisfaction value applied for other customers. Hence, for such customer, the candidates suggested in the list may not be satisfying, although for other supplier they may be. In a second variant of complex attribute, more candidates are available for presentation than in the set of candidates. Hence, a second set of candidates may be provided, candidates of which may be presented to the user subsequently, according to the same mechanism the candidates of the first set are presented to the user. In a third variant of complex attribute, the supplier indicates a customer specific characteristic in the candidates the customer is focused on.

For the first variant, the candidates of the set may be exposed to the user again, in order to possibly evoke a different, and in particular more satisfactory reaction than in the first run. In case of the second variant, it is preferred that the candidates of the second set are presented to the user. The overall best matches, i.e. the best matches of the combined first and second set of candidates are finally presented to the user. In case of the third variant, the complex attribute preferably is converted into a feature in step, and settings of the pattern recognition engine applied to the pictures or videos of the candidates may be adapted in order to reflect this feature. Accordingly, such adapted feature or pattern recognition in the process of identifying the one or more further candidates may lead to a different selection than in the first run, i.e. with the standard setting of the pattern recognition engine. This in turn may lead to a different or modified list of preferred candidates than after the first run.

Besides the facial expression monitored and contributing to the selection of the preferred candidate, screen time for a candidate may contribute to the decision, too. This only makes sense when the user is responsible for the screen time a candidate gets. In such scenario, the screen time per candidate may be measured, and the satisfaction value preferably is assigned also dependent on the candidate screen time. It may be assumed, for example, that the longer the user looks at a candidate the more interested he/she is in the candidate, and vice versa.

Back to the images taken while the user watches a candidate, e.g. on the screen of his/her electronic device: It may be preferred that multiple images are captured per candidate screen time, in order to also capture dynamics in the facial expression of the user. A feature vector may be generated per image, and may be stored. In such scenario, each feature vector is of equal weight to other feature vectors. In a different approach, out of the multiple feature vectors generated per candidate, based on the multiple images taken during the user watching a candidate, a final feature vector per candidate can be calculated, e.g. by averaging the quantities of the individual feature vectors. In this approach, it is desired that a single feature vector is assigned to a single candidate, although multiple images are taken from the user's face while watching the candidate.

The feature vectors are preferably stored in a data structure as to obtain a history of feature vectors. Mathematical operations may be applied to the history of feature vectors, such as averaging operations.

As to the general concept of the present idea, the presentation of candidates to the user is intended to stimulate the visual, auditory, olfactory, tactile or gustatory sense of the user thereby triggering a facial expression recorded by a camera and investigated by a face recognition engine. The facial expression may indicate a sympathy level of the user for the candidate or an antipathy, in different grades.

In particular when the candidates are human beings, the level of sympathy or antipathy can be automatically measured and a selection of a candidate based on the results of these measurements can be suggested.

Accordingly, in such cases, the system and method may be used in a dating platform, for example, or in a platform for women selecting sperm donators, the candidates being males registered with a sperm bank, and being presented to the women by means of pictures.

However, in a different embodiment, the candidates are written text portions. Here, the satisfaction value assigned to a candidate represents an attention level the user shows for the presented written text portion while reading this text portion.

In a different application, the candidates are audio signals and the satisfaction value automatically derived indicates the preference of the user for the presented audio signal.

According to another aspect of the present invention, a computer program product is provided comprising computer code means for controlling a method according to any of the preceding embodiments when executed on a processing unit of a computing device or a network of computing devices.

According to another aspect of the present invention, a server is provided for computer implemented assisting the identification of preferences of a user with respect to different candidates presented to the user. The server may be a server as used in the above system and its embodiments, or may be a different server. The server comprises a face recognition engine configured to extract features from one or more images of the user's face in response to a candidate being presented to the user, and a matching engine configured to assign a satisfaction value to the extracted features, the satisfaction value representing the user's satisfaction with the presented candidate. The matching engine is configured to select, for presentation, one or more further candidates dependent on satisfaction values assigned with reference to candidates presented to the user so far. Accordingly, this server may be implemented such that the database with the candidates is stored in the server or a storage or memory assigned to the server. Accordingly, the matching engine may be fully operated on the server.

According to a further aspect of the present invention, a different server is provided for computer implemented assisting the identification of preferences of a user with respect to different candidates presented to the user. The server may be a server as used in the above system and its embodiments, or may be a different server. The server comprises a face recognition engine configured to extract features from one or more images of the user's face in response to a candidate being presented to the user, and a matching engine configured to assign a satisfaction value to the extracted features, the satisfaction value representing the user's satisfaction with the presented candidate. Now, the matching engine is configured to request a selection of one or more further candidates, for presentation, dependent on satisfaction values assigned with reference to candidates previously presented to the user so far. Accordingly, the database with the candidates may be implemented remote from the server, such that the server only triggers the selection of one or more further candidates. Preferably, in the triggering request the identifier/s of the at least one candidate is included. This at least one candidate is the candidate selected from the candidates presented so far and selected dependent on the satisfaction values that acts as reference candidate

According to another aspect of the present invention, a computer implemented method is provided for assisting a user in identifying preferences with respect to different candidates presented to the user comprising: sending a picture or video of a candidate to an electronic device of the user; receiving one or more images of the user's face from the electronic device captured while the candidate is presented to the user; extracting features from the one or more received images; assigning a satisfaction value to the extracted features, the satisfaction value representing a user's satisfaction with the presented candidate; and selecting, for presentation, one or more further candidates dependent on one or more satisfaction value/s assigned with reference to candidates previously presented to the user. This method may be run on the server that also stores the database.

According to another aspect of the present invention, a computer implemented method is provided for assisting a user in identifying preferences with respect to different candidates presented to the user comprising: sending a picture or video of a candidate to an electronic device of the user; receiving one or more images of the user's face from the electronic device captured while the candidate is presented to the user; extracting features from the one or more received images; assigning a satisfaction value to the extracted features, the satisfaction value representing a user's satisfaction with the presented candidate; and sending a request to another server to select, for presentation, one or more further candidates dependent on satisfaction value/s assigned with reference to candidates previously presented to the user. This method may be run on a server that does not store the database.

According to further aspects of the present invention, computer program products are provided comprising computer code means for controlling the above methods when executed on a processing unit of a corresponding server.

According to another aspect of the present invention, an electronic device is suggested for computer implemented assisting the identification of preferences of a user with respect to different candidates presented to the user, the electronic device comprising a camera arranged and configured to capture images of the user's face, a screen configured to present pictures or videos of candidates of the set to the user, a presentation engine configured to present the pictures or videos of the candidates received via an interface from a server on the screen, and a processing unit configured to trigger the camera to capture one or more images of the user's face in response to a candidate being presented to the user on the screen. The processing unit is configured to transmit the one or more captured images via the interface to the server. The presentation engine is configured to receive, via the interface from the server, the picture/s or video/s or identifier/s of one or more further candidates identified as preferred candidate/s by the server, and is configured to present these picture/s or video/s or identifier/s on the screen. The electronic device may be the device the user uses, wherein in particular a dedicated app provides for the given functionality.

According to a further aspect of the present invention, a computer implemented method for assisting a user in identifying preferences with respect to different candidates presented to the user, comprising: presenting pictures or videos of candidates received via an interface from a server on a screen; triggering a camera to capture one or more images of the user's face in response to a candidate being presented to the user on the screen; transmitting the one or more captured images via an interface to a server; receiving, via the interface, from the server picture/s or video/s or identifier/s of one or more further candidates (identified as preferred candidate/s by the server; and presenting these picture/s or video/s or identifier/s on the screen. This may be the method running on the above or a different electronic device, preferably assigned to the user.

According to a further aspect of the present invention, a computer program product comprising computer code means for controlling such a method when executed on a processing unit of an electronic device.

Other advantageous embodiments are listed in the dependent claims as well as in the description below.

### BRIEF DESCRIPTION OF THE DRAWINGS

The invention will be better understood and objects other than those set forth above will become apparent from the following detailed description thereof. Such description makes reference to the annexed drawings, wherein:

FIG. 1 illustrates a diagram showing the functionality of a system for the computer implemented identification of preferences of a user with respect to candidates presented to the user, according to an embodiment of the present invention;

FIG. 2 illustrates a block diagram of a system according to an embodiment of the present invention;

FIG. 3 illustrates a schematic data structure used in an embodiment of the present invention;

FIG. 4 illustrates a concept of the selection of candidates, as used in an embodiment of the present invention;

FIG. 5 illustrates a flow chart of preparatory steps for a method for computer implemented identification of preferences of a user with respect to candidates presented to the user, according to embodiments of the present invention; and

FIGS. 6 and 7 illustrate flow charts of methods for computer implemented identification of preferences of a user with respect to candidates presented to the user, according to embodiments of the present invention.

### MODES FOR CARRYING OUT THE INVENTION

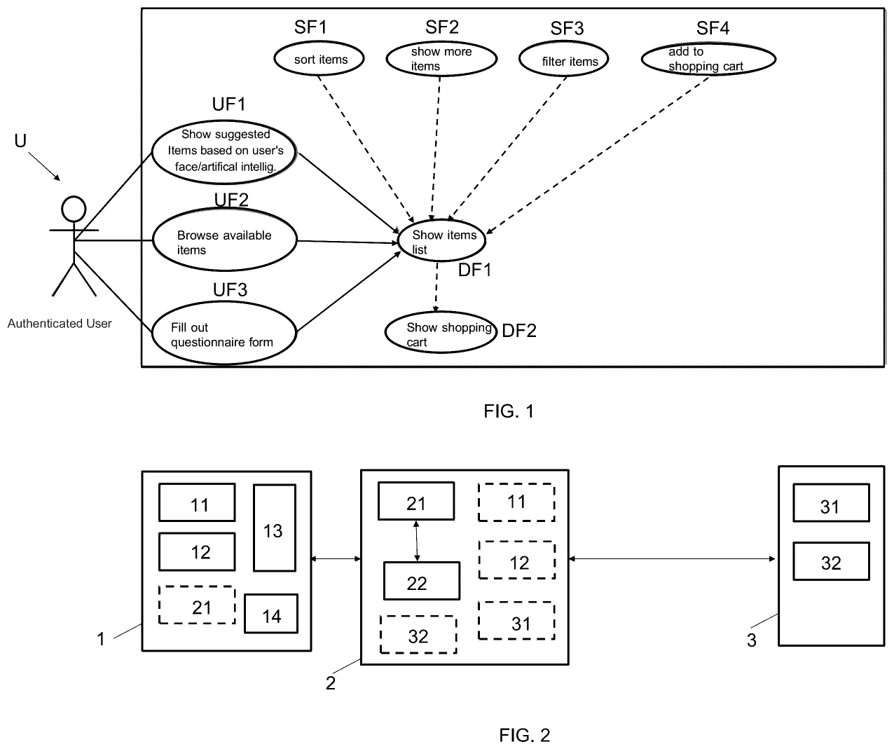

FIG. 1 illustrates a diagram showing the functionality of a system for the computer implemented identification of preferences of a user with respect to candidates presented to the user, according to an embodiment of the present invention. The user U authenticated to the system/service is preferably offered all of the user functionalities UF1-UF3 at a time, or only UF1 and UF3 in combination, or UF1 in another embodiment.

User functionality UF1 offers the user to be exposed to suggested candidates, also referred to as items. The system monitors the facial expression of the user during and also preferably before and after such exposure to a candidate and converts the respective facial expressions into a satisfactory values. Subject to the satisfactory values evaluated in response to one or more presented items, new items to be presented to the user are selected.

User functionality UF2 offers the user to browse through available candidates, without any feedback from the user's facial expression as to the selection of further candidates to be presented. Accordingly, a face recognition engine and a matching engine are preferably implemented and operable in the system, however, do not impact the selection and/or order of future candidates.

User functionality UF3 refers to preparatory measures for one of UF1 and UF2. The filling out of a questionnaire may be understood as a preferably computer implemented interaction with the user in order for the system and service to learn about the user's preferences, disconnected from any specific items or candidates, but of general nature. The data gathered during UF3 may also be evaluated, classified, and/or otherwise processed, the result of which may be considered as meta-data of the user, and indicates preferences and/or averseness. Preferably, user functionality UF3 is implemented in combination with user functionality UF1.

FIG. 1 in addition lists exemplary service functionalities SF1 to SF4. Such service functionalities SF1 to SF4 include the way the service provider via its server 2, see FIG. 2, improves the interaction and/or way of selection out of a set of candidates. Service functionality SF1 includes the items/candidates being preselected from a bigger set of items/candidates. And/or the items/candidates or the preselected items/candidates are sorted in order according to an algorithm, e.g. taking into account the preferences/averseness of the user determined by the process representing user functionality UF3. Service functionality SF2 may evoke to show more items/candidates to the user, preferably at a determined point in time, subject to the number of items/candidates already presented to the user, and/or subject to the satisfactory value determined for the items/candidates presented to the user in the past, in particular in case the satisfactory value for all the items/candidates presented in the past is not considered as sufficient. Service functionality SF3 comprises the filtering of items/candidates. This preferably includes the filtering of further items/candidates to be presented according to certain criteria, and in particular subject to the evaluation results, in particular the satisfactory values determined for items/candidates presented in the past. Accordingly, service functionality SF3 strongly supports user functionality UF1. Finally, service functionality SF4 includes the availability of a shopping cart for the items/candidates suggested as preferred to the user and/or selected by the user from the list of suggested candidates. Additional functionality may include the handling of the shopping cart, the implementation of a payment process, the managing of user profiles, etc.

For user interaction, display functionalities DF1 and DF2 are implemented. This includes the display of items/candidates to the user as display functionality DF1, and/or the display of the shopping cart to the user as display functionality DF2, for example.

FIG. 2 illustrates a block diagram of a system according to an embodiment of the present invention. The system comprises a user assigned electronic device 1, a server 2 assigned to a service provider providing the services for the computer implemented identification of preferences of a user with respect to candidates presented to the user. Another server 3 is assigned to a customer of the service provider. The electronic device 1 may, for example, be one of a smartphone, a tablet computer, a laptop, another kind of handheld computer, a stationary computer such as a PC, or another kind of stationary computer. Next to a processing unit (not shown), the electronic device 1 at least comprises a display 11 and a camera 12, either integrated or connectable to, as well as a processing unit (not shown). The camera 11 is configured to record the facial expression of the user in the scenario of the computer implemented identification of preferences of the user, while the display 12 is configured to present candidates to the user, via a presentation engine 14. In addition, the electronic device 1 comprises an interface for communicating with the server 2 of the service provider. The communication is indicated by the double arrow and allows wireless and/or wirebound exchange of data between the electronic device 1 and the server 2. In particular, the electronic device 1 may comprise an application (app) 13 configured to implement the desired functionality on the electronic device of the user. Such app 13 may be downloaded by the user to the electronic device 1 prior to usage of the envisaged service. The app 13 is configured to provide a graphical user interface for the user to control the app 13, settings of the app 13, the process executed by the app 13, the presentation engine 14 configured to present candidates received from the server 1 on the display 12, e.g. at a given rate and/or on demand. The app 13 further may be configured to control recording of images from the user's face via the camera 11, e.g. at a given rate while the user watches the candidates and the forwarding of these images to the server 2. Preferably, the app 13 is configured to map the images recorded by the camera 11 to the pictures of the candidates while the images are recorded.

The server 2 comprises a corresponding interface for communicating with the electronic device 1, and a processing unit. The processing unit, in combination with corresponding software preferably implements a face recognition engine 21 and a matching engine 22. The face recognition engine 21 is configured to computer implemented identify features of images recorded by the camera 11 and transmitted to the server 2. The matching engine 22 is configured to, in response to features identified by the face recognition engine 22, computer implemented identify preferences of the user with respect to candidates presented to the user on the display 12. In one embodiment, the matching engine 22 may output the one or more matched candidates to the electronic device 1.

Preferably, the server 2 of the service provider is connected to a server 3 of the customer of the service offered by the service provider. Such server 3 may, next to a processing unit (not shown), provide a database 31 with candidates to be presented to users. Accordingly, the server 2 and the other server 3 may communicate via a suitable interface with each other, as indicated by the double arrow. The other server 3 may in addition comprise a pattern recognition engine 32 for extracting characteristics from the candidates stored in the database 31.

However, in alternate embodiments, resources of the system may be assigned differently to the hardware entities 1,2,3: In a first embodiment, the server 3 of the customer is not existent or is not involved. In such scenario, the database 31 comprising the candidates is supplied from the customer to the service provider, and finally, is resident on the server 2 of the service provider. The pattern recognition engine 32 may be resident on the server 2, too, and may in one embodiment be identical to the face recognition engine 21. Such scenarios are indicated by the dashed rectangles in server 2.

In a further scenario, portions of the computer implemented intelligence is embedded in the app 13, and hence on the electronic device 3 rather than in the server 2 of the service provider: For example, the face recognition engine 21 may be resident on the electronic device 1 in one example, such that the sub-engines of feature extraction etc. are run locally on the electronic device 1 of the user. This scenario is indicated by the dashed rectangle 21 located in the electronic device 1.

In another scenario all the functionality may be integrated at the service provider, i.e. in or connected to the server 2. In such scenario, e.g. the camera 11 and the display 12 may be provided in or directly connected to the server 2. In such scenario, the user may need to go to the service provider's location in order to benefit from the service. Accordingly, the service provider may offers a desk at its premises with a camera 21 and a display 22 directly connected to the server 2, on which the face recognition engine 21 and the matching engine 22 are run. In this scenario, no electronic device 1 of the user needs to be involved at all.

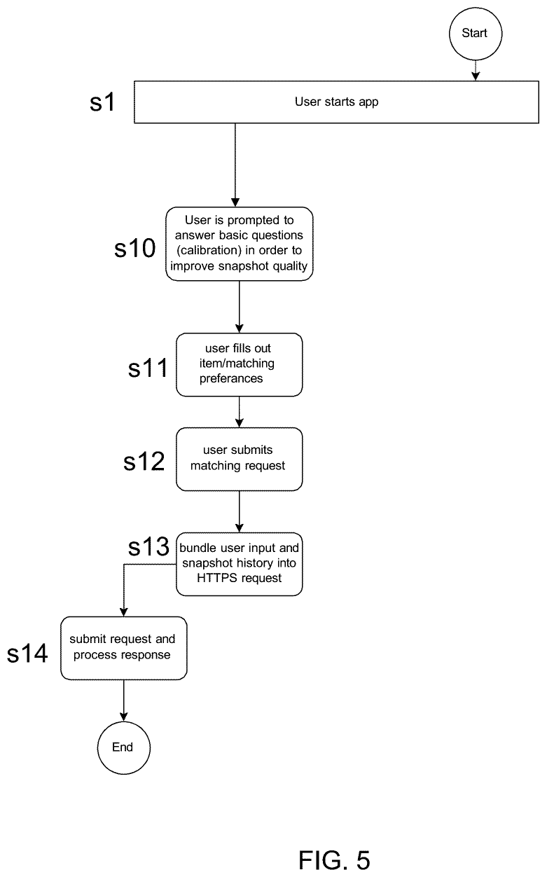

FIG. 5 illustrates a flow chart of preparatory steps for a method for computer implemented identification of preferences of a user with respect to candidates presented to the user, according to embodiments of the present invention. This may correspond to user functionality UF3 of FIG. 1, in one embodiment. These preparatory steps are preferably performed after the user has registered with the service provider and in response to starting the app for the first time. Alternatively, these steps may already be performed during the registration procedure with the service provider. Registration typically is understood as a computer implemented registration of the user for the services offered by the service provider, e.g. by calling the service providers webpage and running a registration procedure, or by downloading the service provider's app and registering via the app. The registration typically includes the generation of an account for the user accessible via a user id and a password. It also involves the deposition of personal data such as address, dates of birth, etc. and/or the deposition of payment data. In addition to such standard registration data, it is preferred that the user is prompted in step s10 to answer basic questions, specifically in relation to the service, and in particular in relation to the items/candidates to be presented to the user. For example, in case the items to be presented are pictures of a dish or a menu, general preferences of the user in relation with food are prompted e.g. if the user prefers Asian over European cuisine, if the user prefers meat over vegetarian cuisine, etc. For example, in case the items to be presented are pictures of human beings, e.g. in a dating platform, general preferences of the user in relation to partners are prompted, e.g. which sex the user prefers, which colour of hair, which age, etc. In view of the rather generic level of preferences the user is prompted for, this procedure may also be considered as calibration for the subsequent process of computer implemented determination of user preferences, given that such basic parameters, also referred to as meta data, may later on serve as one of the parameters to compare to and/or as verification for selected preferences.

In step s11, the user may indicate such matching/item preferences, and submits the corresponding data to the server in step s12, where the data is added to possibly existing other user data in step s13.

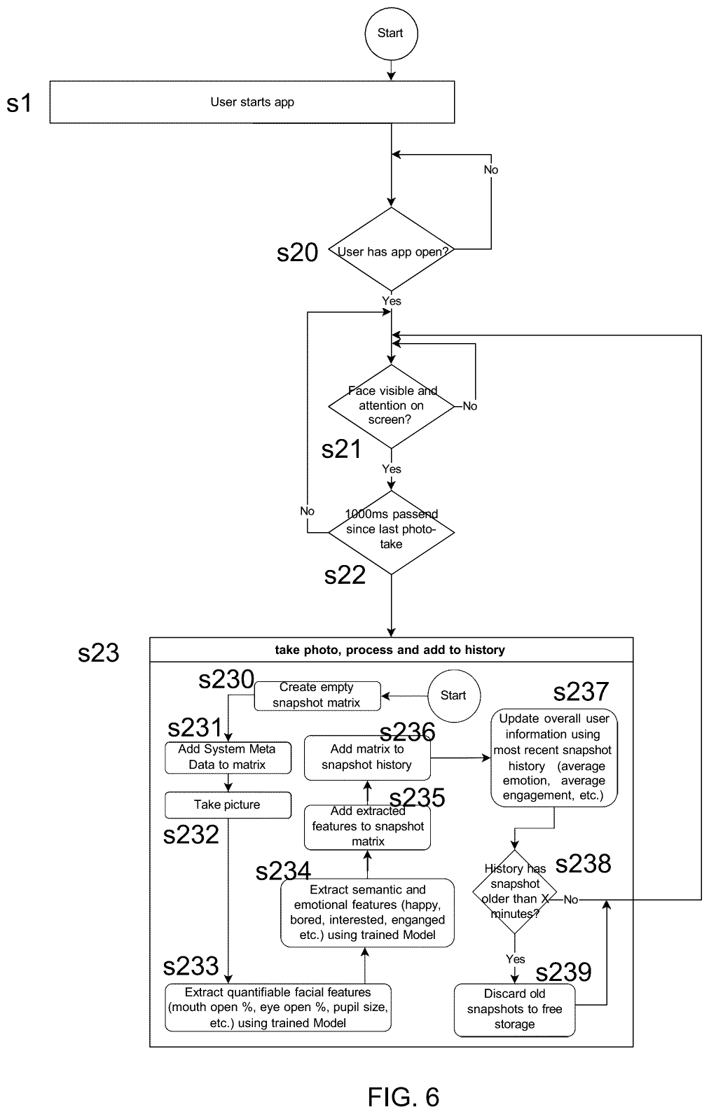

FIG. 6 illustrates a flow chart of a method for computer implemented identification of preferences of a user with respect to candidates presented to the user, according to an embodiment of the present invention. This process preferably runs in response to the user starting the app in step s1, however, as a precondition, the user already having run through the preparatory steps of FIG. 5, i.e. preferably after the user having registered with the service provider and the user having filled the user's metadata with respect to the specific service. In step s20 it is monitored, if the app not only is started but also is opened which is taken as indication the user desires to run the process right now. In case the app is started but in idle mode (No), it is continued to be monitored if the app will be opened. In case the app is open indeed (Yes), it is investigated in step s21, if the user's face is visible and/or his/her attention is directed onto the screen/display of the electronic device (assuming the electronic device scenario of FIG. 2). This may be performed e.g. by means of the camera 21. Hence, in response to the app being opened in step s20, the camera 11 is be under control of the app. Initial images may be recorded and evaluated as to if the user's face visible on those images, or if not. This may be supported by a face recognition algorithm, which presently only needs to evaluate, if the users face is in proper alignment with the camera. In case it shall also be determined if the user looks at the screen and hence is prepared to receive the first items/candidates on the screen, the face recognition algorithm may e.g. extract the user's eyes from the images recorded, and determine if the user's eyes are directed at the screen.

In case these computer implemented assessments are answered positive (yes) it is continued with step s22, whereas in case these assessments are answered negative (no), step s21 is implemented again and again, as along as the user's face is properly captured by the camera and as the user's attention is drawn onto the screen. Specifically, an instruction message may be output to the user on the display, e.g. to move the head to a better position in terms of face capture by the camera.

In step s22, it is determined if a picture was very recently taken. If yes, it is waited until the timing threshold is exceeded, and the image capturing and evaluation process s23 is started. Note that image and photo are assumed to be identical in the context of FIG. 6.

In step s230, an empty snapshot matrix is generated. The snapshot matrix is considered as data structure or bin to be filled with data associated with one snapshot. A snapshot is identical to an image taken by the camera.

In step s231, system meta data, such as ??, is added to the matrix. In next step s232, the image is taken/recorded/captured by the camera, and preferably is at least temporarily stored.

The next two steps s233 and s234 refer to the analysis of the captured image, in particular of the content of the image. Given that in step s21 the taking of the image is prepared to enable capturing the face of the user, it is the face of the user that is to be analysed. The computer implemented analysis, which generally also is named image processing, in particular makes use of feature extraction. A feature generally is considered a shape, contour or area recognizable in the digitized image by way of e.g. comparing colours etc. Given that the image is the image of a human face, features may include e.g. eyebrows, eyes, nose, mouth, lid, cheek, etc. In feature extraction, the volume of data inherent in a pixel based digital image is transformed into a set of features also referred to as feature vector, and thereby is significantly reduced.

In the present example, the features to be extracted are defined upfront, e.g. by means of feature selection. For example, it is defined that the above set of exemplary features mouth, nose, eyes, etc., are selected as relevant features for subsequent feature extraction from the images taken. Such selected features may then be classified into quantifiable features and non-quantifiable features. In the class of quantifiable features, a metric can be applied, such as a distance: mouth open, eye open, pupil size, nose size, etc. In the class of non-quantifiable features, no such single metric can be assigned. Instead semantic states equivalent to facial expressions such as happy, interested, bored, engaged, are extracted. Both class of features are extracted by using a trained model.

Once extracted in steps s233 and s234, the extracted features are added in step s235 to the snapshot matrix for this image, and the so filled snapshot matrix is added to the snapshot history in step s236. The snapshot history is considered as aggregation of snapshot matrices of the past, e.g. covering the entire user session starting with the transition from step s20 to step s21.

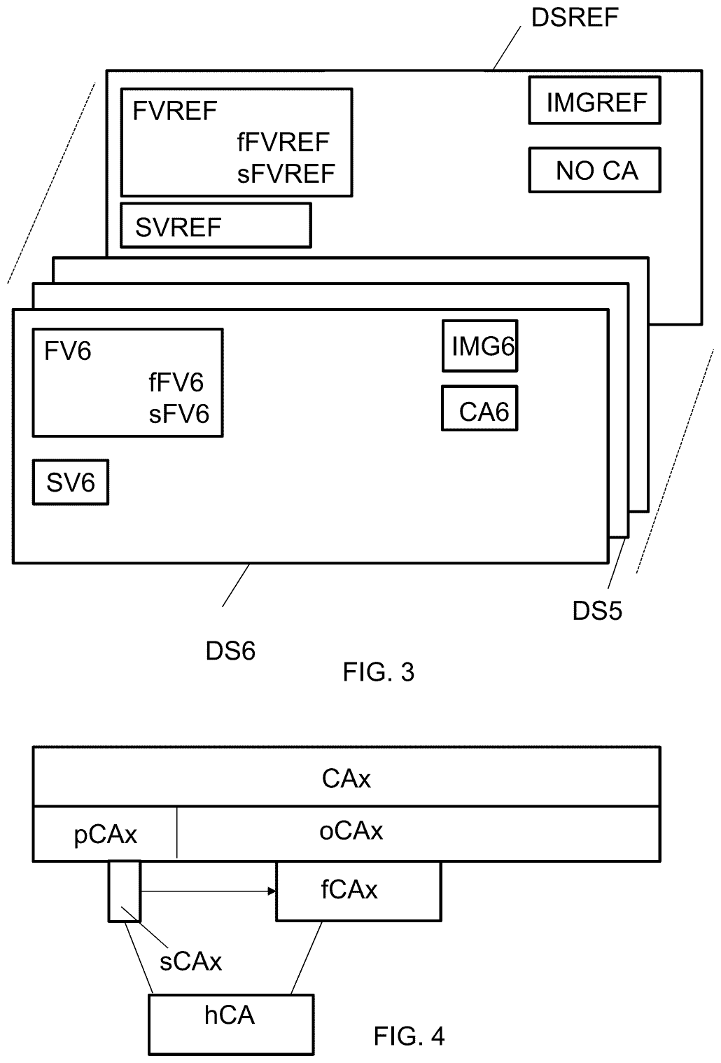

FIG. 3 illustrates a schematic and sample data structure history, i.e. a snapshot history, as is used in an embodiment of the present invention. The data structure history shown comprises sample data structures DS5, DS6, etc. and a reference data structure DSREF. Each data structure DSx, also referred to as snapshot matrix, comprises data entries for the candidate CAx presented to the user, the image IMGx taken during the candidate CAx being presented to the user, a feature vector FVx extracted from the image IMGx taken, and a satisfaction value SVx assigned to the feature vector FVx. The data structure DS6 in the front shows these data entries for e.g. candidate no 6 being presented to the user. As will be explained in more detail later on, the feature vector FV6 may be composed from a first feature vector fFV6 and a second feature vector sFV6. Such data structure DSREF also is generated for a reference image IMGREF, which is an image taken while the user is not exposed to any candidate: This is the reason why the corresponding box is labelled with “NO CA”. Such reference image IMGREF nevertheless is analysed as to the facial expression of the user and provides valuable information, i.e. how the user looks like without stimulation. In this regard, the feature vector is also considered as reference feature vector.

Returning to FIG. 6, in step s237 a further analysis step is performed, not only with respect present feature vector, but preferably across all or a subset of the feature vectors stored in the past, and hence referring to candidates already presented to the user. Then the capturing and processing of an individual image is terminated.

In step s238 it is investigated, if the snapshot history includes snapshots older than x minutes, preferably AND-combined with an evaluation of the satisfaction values assigned to the snapshots in the snapshot history so far. In case all satisfaction values assigned with respect to the candidates presented so far are below a threshold that e.g. indicates a minimum of satisfaction required for the system to suggest a candidate to the user, then, although considerable effort taken so far, none of the presented candidates seem to meet the expectations of the user. In case of such situation (yes), the snapshot history is discarded in step s239. Else (no) the process is continued without any such removal of snapshots to free storage. It is returned to step s21, and provided the timing requirement is fulfilled in step s22, a further image is taken in step s23.

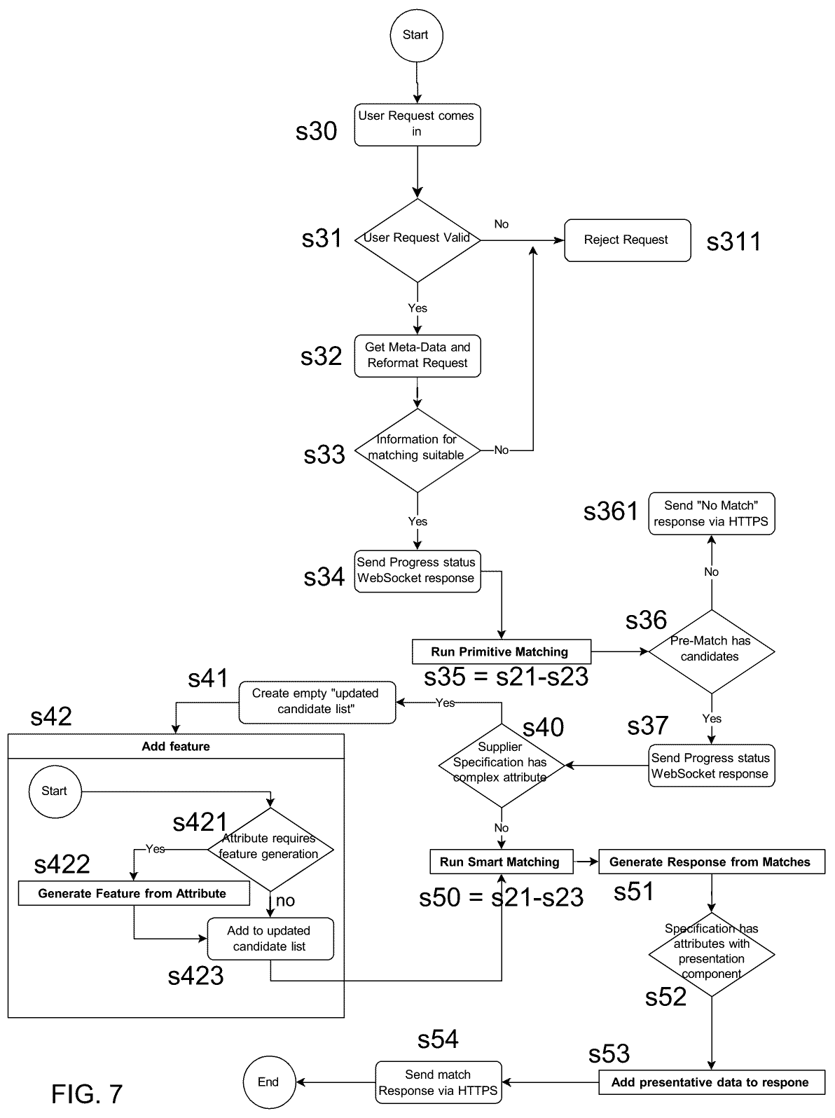

FIG. 7 illustrates a flow chart of a methods for computer implemented identification of preferences of a user with respect to candidates presented to the user, according to an embodiment of the present invention. Step s30 referring to an incoming user request may be comprehended as step identical to step s20 of FIG. 6. Subsequent steps s31 to s34 preferably are additional preparatory steps, before the process according to steps s21 to 23 of FIG. 6 is run. E.g., in step s31 it may be verified, if the user request is valid. This may make sense in case user can submit request without being registered, for example. In case the request is not valid (no), the request is rejected in step s311, or alternatively, the user may be prompted to e.g. register. In case the request is valid (yes), it is prompted for metadata in step s32, in particular for user meta-data. It is noted that such user meta-data may be gathered by the process illustrated in FIG. 5. In addition, in step s32 the user request may be reformatted if needed for further processing. In step s33, it is verified if the available meta-data is sufficient. If not (no), the user request is rejected in step s311, or alternatively, the user may be prompted to provide the required meta-data. If so (yes), the progress status of these preparatory steps is reported as a WebSocket response. Then, the so-called primitive matching routine is executed in step s35. This may include the execution of step s21 to s23 of FIG. 6, and hence, the presentation of various candidates, the capturing of corresponding user images, the associate image processing including the matching step of assigning a satisfaction value per image and/or candidate.

Once the “primitive” matching is terminated, a list of one or more matches, i.e. candidates identified as preferred out of the presented ones is generated. The selection criteria for this list may, e.g., include all candidates with a satisfaction value exceeding a given threshold. The candidates selected for the list are also called “Pre-Matches” and most likely represent the one or more candidates having achieved the highest satisfaction values out of the one presented to the user.

This list is verified in step s36 given that this list may also be empty in case no candidate has evoked the desired reaction with the user. Hence, in case no Pre-Match was found (no), a corresponding message is sent to the user in step s361. Otherwise (yes), a corresponding message is sent to the user in step s37, too, that there are “Pre-Matches”. In the next step s40, it is verified if the supplier of the candidates, i.e. the customer of the service provider, is flagged with a “complex attribute”.

The “complex attribute” may indicate one or more of the following:
1) the customer may require a higher satisfaction value threshold for a candidate to be added to the list of suggested candidates than a default satisfaction value applied for other customers. Hence, for the present customer, the suggested Pre-Match candidates may not be sufficient.
2) there are more candidates available for presentation, i.e. candidates not included in the set of candidates yet, but included in a second set of candidates, for example, not yet released by the customer to the service provider or to the user;
3) the complex attribute identifies a customer specific characteristic in the candidates the customer is focused on.

If the verification step s40 shows a complex attribute to be respected (yes) a new, empty candidate list is generated in step s41, and in step s42 the process of adding the feature is executed. It is verified in step s421 if the attribute requires new feature recognition steps. This is not the case (no) in above options 1) and 2) such that either the complete set of candidates is added to the list in step s423 (option 1)), or the second set of candidates is added to the list (option 2)).

However, in case of above option 3) the complex attribute is converted into a feature in step s422. E.g. settings of the pattern recognition engine applied to the pictures or videos of the candidates may be adapted in order to better reflect the special attribute/s of the customer. The preferably entire set of candidates may be processed by such modified pattern recognition engine and a subset of candidate may be identified matching the complex attribute. Such subset of candidates may then be added to the list in step s423.

Then, the resulting list of candidates undergo the “Smart Matching” of step s50 which basically represents the steps 21 to s23 of FIG. 6. Accordingly, instead of the set of candidates, the list of candidates assembled from the list generated in step s35 and updated or added by the candidates identified in step 423, builds the reservoir for running the face recognition and matching processes.

Result is a new list of candidates, i.e. new “Matches” which may even include one or more of the “Pre-Matches”, but not necessarily has to, in particular in view of a second set of candidates being presented (option 2)), or in view of a customer specific focus on candidates with certain attributes/characteristics. The matches are selected and presented to the user in steps s51 to s54.

FIG. 4 illustrates the concept of selection of candidates: The original set of candidates is CAx. These may, in one embodiment, be the candidates available for inspection. The system/method starts with presenting a group of candidates pCAx, out of the original set of candidates CAx. The selection or order in which the candidates pCAx are selected from CAx can be random or can follow an algorithm, e.g. selecting the most diverse candidates. At a given point in time, indicated by the vertical line, the original set of candidates CSx is split into the candidates pCAx already presented, and the candidates oCAx not yet presented, also referred to as other candidates earlier in the specification, all relative to the user session. At that point in time, which may be a fixed point in time, or may be a time after having presented a fixed number of candidates, the sub-process of selecting further one or more candidates fCAx to be presented to the user is started. These further candidates fCAx are preferably a subset of the candidates oCAx not presented yet to the user. The further candidates fCAx to be presented are selected by means of at least one candidate sCAx selected from the candidates pCAx already presented to the user. This selected candidate sCAx preferably is selected based on its satisfaction value. E.g. its satisfaction value may be the highest among all candidates pCAx presented to the user so far. The selected candidate sCAx in turn ma define the further candidates fCAx, which preferably are the candidates out of oCAx most similar to sCAx. Finally, the system/process suggest one or more candidates hCA showing a high satisfaction value out of the combined groups of sCAx and fCAx. In a different scenario, hCAx may be selected out of the combined groups of pCAx and fCAx.

1-49. (canceled)

50. A system for computer implemented assisting the identification of preferences of a user with respect to different candidates presented to the user, comprising:
a camera arranged and configured to capture images of the user's face;
a face recognition engine configured to extract features from one or more captured images of the user's face in response to a candidate being presented to the user;
a matching engine configured to assign a satisfaction value to the extracted features, the satisfaction value representing the user's satisfaction with the presented candidate; and
wherein the matching engine is configured to select, for presentation, one or more further candidates dependent on satisfaction values assigned with reference to candidates presented to the user so far.

51. The system according to claim 50,
wherein the face recognition engine comprises a feature extractor trained to extract facial characteristics,
wherein the extracted features are provided as a feature vector comparable to feature vectors generated for other captured images,
preferably wherein the facial characteristics include one or more of gender, age, facial landmarks, facial expression.

52. The system according to claim 51,
wherein the feature extractor comprises:
a first feature extractor module trained to extract quantifiable features from the image/s, and
a second feature extractor module trained to extract other features from the image/s subject to the quantifiable features extracted by the first feature extractor module, wherein the second feature extractor module is configured to select, subject to the quantifiable extracted features supplied by the first feature extractor, a model out of a set of models, to be applied for extracting the other features,
preferably wherein the quantifiable extracted features include landmarks in the face of the user,
preferably wherein the other extracted features include semantic features representing the facial expression of the user.

53. The system according to claim 51,
wherein the face recognition engine is configured to extract reference features from one or more reference images captured of the user's face absent any stimulus in form of the presentation of a candidate,
wherein the extracted reference features are provided in form of a reference feature vector comparable to feature vectors generated for other captured images,
wherein the matching engine is configured to calibrate the feature vector with respect to the reference feature vector to obtain one or more relative quantities,
wherein the matching engine is configured to estimate the satisfaction value dependent on the one or more relative quantities.

54. The system according to claim 51,
wherein the matching engine is configured to compare the feature vector with one or more other feature vectors to obtain one or more relative quantities,
wherein the matching engine is configured to estimate the satisfaction value dependent on the one or more relative quantities.

55. The system according to claim 50,
wherein the matching engine is configured to select the one or more further candidates by way of:
selecting at least one candidate out of the candidates presented so far subject to the corresponding satisfaction values,
selecting the one or more further candidates based on a similarity measure between the at least one selected candidate and other candidates not presented yet,
preferably wherein the at least one selected candidate is the candidate with the highest satisfaction value.

56. The system according to claim 55,
comprising a pattern recognition engine for extracting features from the pictures or videos of the candidates,
wherein the pattern recognition engine is configured to extract features from the pictures or videos of the other candidates thereby generating corresponding candidate feature vectors,
wherein the pattern recognition engine is configured to extract features from the picture or video of the at least one selected candidate thereby generating a corresponding reference candidate feature vector,
wherein the matching engine is configured to compare the reference candidate feature vector with the candidate feature vectors to obtain one or more relative quantities, and wherein the matching engine is configured to select the one or more further candidates subject to the one or more relative quantities,
preferably according to one or more of the highest or lowest one or more relative quantities,
preferably wherein the matching engine is configured to output at least the candidate with the highest satisfaction value.

57. A computer implemented method for assisting a user in identifying preferences with respect to different candidates presented to the user, comprising:
presenting a candidate to the user;
capturing one or more images of the face of the user while the candidate is presented to the user;
extracting features from the one or more captured images of the user's face, assigning a satisfaction value to the extracted features, the satisfaction value representing a user's satisfaction with the presented candidate,
selecting, for presentation, one or more further candidates dependent on satisfaction values assigned with reference to candidates presented to the user so far.

58. The method according to claim 57, comprising:
extracting quantifiable features first from the image/s resulting in a first feature vector;
subsequently extracting other features from the image/s subject to the extracted quantifiable features, resulting in a second feature vector;
combining first and second feature vectors into a feature vector assigned to the image/s; and
storing the feature vector in a data structure, preferably in combination with one or more of:
the one or more images underlying the feature vector,
the picture or the video or an identifier for the associate candidate, and
the assigned satisfaction value.

59. The method according to claim 58, comprising:
selecting a facial model based on one or more of the extracted quantifiable features, and
applying the selected facial model in the subsequent step of extracting the other features,
preferably wherein the facial model is a facial model representing an ethnic group the user is identified to belong to based on the one or more extracted quantifiable features.

60. The method according to claim 57,
capturing one or more reference images of the user's face while no candidate is presented to the user;
extracting reference features from the one or more captured reference images of the user's face, and
generating a reference feature vector from the extracted reference features comparable to feature vectors generated for other captured images.

61. The method according to claim 60,
wherein the one or more reference images are captured prior to the user being presented any candidate,
preferably wherein the candidates are presented to the user on a screen in fixed intervals with a break between two intervals in which break no candidate is shown,
preferably wherein one or more additional reference images are captured during such one or more breaks.

62. The method according to claim 60,
calibrating the feature vector with respect to the reference feature vector to obtain one or more relative quantities, and
estimating the satisfaction value dependent on the one or more relative quantities.

63. The method according to claim 57,
comparing the feature vector with one or more other feature vectors to obtain one or more relative quantities, and
estimating the satisfaction value dependent on the one or more relative quantities.

64. The method according to claim 57, comprising
selecting the one or more further candidates by way of:
selecting at least one candidate out of the candidates presented subject to the corresponding satisfaction values,
selecting the one or more further candidates based on a similarity measure between the least one selected candidate and other candidates not presented yet,
preferably wherein the at least one selected candidate is the candidate with the highest satisfaction value.

65. The method according to claim 64,
wherein the candidates of the set are represented by one of human beings, animals, items, text and scenes, or a combination thereof,
wherein the candidates are presented to the user in form of pictures or videos on a display,
the method further comprising:
extracting features from the picture or video of the at least one selected candidate thereby generating a corresponding reference candidate feature vector,
extracting features from the pictures or videos of other candidates not presented yet thereby generating corresponding candidate feature vectors,
comparing the reference candidate feature vector with the candidate feature vectors to obtain one or more relative quantities, and
selecting the one or more further candidates dependent on the one or more relative quantities,
preferably selecting the one or more further candidates according to one or more of the highest and lowest one or more relative quantities.

66. The method according to claim 57,
presenting at least the candidate with the highest satisfaction value to the user,
preferably wherein any candidates to be presented are presented on a screen,
preferably wherein the user browses the candidates suggested on the screen.

67. The method according to claim 57,
wherein candidate screen time for presenting a candidate to the user is variable and controlled by the user,
wherein the candidate screen time is measured, and
wherein the satisfaction value is assigned also dependent on the candidate screen time.

68. A computer implemented method for assisting a user in identifying preferences with respect to different candidates presented to the user, comprising:
sending a picture or video of a candidate to an electronic device of the user;
receiving one or more images of the user's face from the electronic device captured while the candidate is presented to the user;
extracting features from the one or more received images;
assigning a satisfaction value to the extracted features, the satisfaction value representing a user's satisfaction with the presented candidate, and
sending a request to another server to select, for presentation, one or more further candidates dependent on satisfaction value/s assigned with reference to candidates previously presented to the user.
